(19) United States
(12) Patent Application Publication
(10) Pub. No.: US 2025/0131343 A1
(43) Pub. Date: Apr. 24, 2025

(54) SERVER APPARATUS, CONTROL METHOD OF SERVER APPARATUS, AND NON-TRANSITORY COMPUTER-READABLE STORAGE MEDIUM

(71) Applicant: NEC Corporation, Tokyo (JP)

(72) Inventor: Kenichi SASADA, Tokyo (JP)

(73) Assignee: NEC Corporation, Tokyo (JP)

(21) Appl. No.: 18/904,241

(22) Filed: Oct. 2, 2024

(30) Foreign Application Priority Data
Oct. 24, 2023 (JP) 2023-182330

(51) Int. Cl. G06Q 10/02; G06F 21/32; G06Q 50/12; G06V 20/52; G06V 40/16

(52) U.S. Cl. CPC G06Q 10/02; G06F 21/32; G06Q 50/12; G06V 20/52; G06V 40/171; G06V 40/172

(57) ABSTRACT

A server apparatus includes a storing means, an acquiring means, a determining means, and a notifying means. The storing means stores biometric information and reservation information for each of a plurality of reservation holders of hotel stay. The acquiring means acquires biometric information of a visitor who has visited a hotel. The determining means identifies the visitor from among the plurality of reservation holders of hotel stay by performing a matching processing using the acquired biometric information and the stored biometric information, and determines whether or not the identified visitor is allowed to check in based on the reservation information of the identified visitor. When it is determined that the identified visitor is allowed to check in, the notifying means sets the identified visitor as a hotel guest and notifies a terminal possessed by the hotel guest of a guest room number assigned to the hotel guest.

### INCORPORATION BY REFERENCE

This application is based upon and claims the benefit of priority from Japanese Patent Application No. 2023-182330, filed on Oct. 24, 2023, the disclosure of which is incorporated herein in its entirety by reference.

### TECHNICAL FIELD

The present invention relates to a server apparatus, a control method of a server apparatus, and a non-transitory computer-readable storage medium.

### BACKGROUND ART

There exists technology related to biometric authentication and face recognition.

For example, Patent Literature 1 (JP2022-001988 A) describes appropriate management of face recognition services executed at various facilities.

A face recognition management system of Patent Literature 1 is a face recognition management system that includes a face recognition management server and face recognition terminals installed in a plurality of facilities.

The face recognition management server stores face recognition management information for each user, which includes face recognition information for recognizing a user. The face recognition management server transmits face recognition usage information that includes face recognition information from the user terminal to a facility permitted by the user, so that a face recognition terminal installed at the facility can perform a face recognition process for the user.

Patent Literature 1 discloses a check-in procedure in a hotel as an example of application of a face recognition service. The check-in procedure in Patent Literature 1 is performed at the face recognition terminal installed at a front desk of the hotel (see paragraph [0055], and so on, in Patent Literature 1). In other words, a hotel user is required to stop by the front desk for the check-in procedure.

However, the hotel user desires to complete the check-in procedure more smoothly without stopping by the front desk of the hotel.

### SUMMARY

It is a main object of the present invention to provide a server apparatus, a control method of a server apparatus, and a program, which contribute to improving convenience for hotel users.

According to a first aspect of the present invention, there is provided a server apparatus, including: a storing means that stores biometric information and reservation information for each of a plurality of reservation holders of hotel stay; an acquiring means that acquires biometric information of a visitor who has visited a hotel; a determining means that identifies the visitor from among the plurality of reservation holders of hotel stay by performing a matching processing using the acquired biometric information and the stored biometric information, and determines whether or not the identified visitor is allowed to check in based on the reservation information of the identified visitor; and a notifying means that sets the identified visitor as a hotel guest when the identified visitor is allowed to check in and notifies a terminal possessed by the hotel guest of a guest room number assigned to the hotel guest.

According to a second aspect of the present invention, there is provided a control method of a server apparatus, the control method including: a storing step that stores biometric information and reservation information for each of a plurality of reservation holders of hotel stay; an acquiring step that acquires biometric information of a visitor who has visited a hotel; a determining step that identifies the visitor from among the plurality of reservation holders of hotel stay by performing a matching processing using the acquired biometric information and the stored biometric information, and determines whether or not the identified visitor is allowed to check in based on the reservation information of the identified visitor; and a notifying step that sets the identified visitor as a hotel guest when the identified visitor is allowed to check in and notifies a terminal possessed by the hotel guest of a guest room number assigned to the hotel guest.

According to a third aspect of the present invention, there is provided a program causing a computer mounted on a server apparatus to perform processing for: a storing processing that stores biometric information and reservation information for each of a plurality of reservation holders of hotel stay; an acquiring processing that acquires biometric information of a visitor who has visited a hotel; a determining processing that identifies the visitor from among the plurality of reservation holders of hotel stay by performing a matching processing using the acquired biometric information and the stored biometric information, and determines whether or not the identified visitor is allowed to check in based on the reservation information of the identified visitor; and a notifying processing that sets the identified visitor as a hotel guest when the identified visitor is allowed to check in and notifies a terminal possessed by the hotel guest of a guest room number assigned to the hotel guest.

### BRIEF DESCRIPTION OF THE DRAWINGS

Exemplary features and advantages of the present invention will become apparent from the following detailed description when taken with the accompanying drawings in which:

FIG. 1 is a diagram illustrating an outline of an example embodiment;

FIG. 2 is a flowchart illustrating an outline of an operation of an example embodiment;

FIG. 3 is a diagram illustrating an example of a schematic configuration of an information processing system according to an example embodiment of the present disclosure;

FIG. 4 is a diagram illustrating an example of a configuration within a hotel according to the example embodiment of the present disclosure;

FIG. 5 is a diagram illustrating an example of a display of a terminal according to an example embodiment of the present disclosure;

FIG. 6 is a diagram illustrating an example of a display of the terminal according to the example embodiment of the present disclosure;

FIG. 7 is a diagram illustrating an operation of the information processing system according to the example embodiment of the present disclosure;

FIG. 8 is a diagram illustrating an operation of the information processing system according to the example embodiment of the present disclosure;

FIG. 9 is a diagram illustrating an example of a display of the terminal according to the example embodiment of the present disclosure;

FIG. 10 is a diagram illustrating an example of a display of the terminal according to the example embodiment of the present disclosure;

FIG. 11 is a diagram illustrating an example of a processing configuration of a server apparatus according to the example embodiment of the present disclosure;

FIG. 12 is a diagram illustrating an example of a reservation holder management database according to the example embodiment of the present disclosure;

FIG. 13 is a flowchart illustrating an example of an operation of a check-in control unit according to the example embodiment of the present disclosure;

FIG. 14 is a diagram illustrating an example of a processing configuration of a signage according to the example embodiment of the present disclosure;

FIG. 15 is a sequence diagram illustrating an example of an operation of the information processing system according to the example embodiment of the present disclosure;

FIG. 16 is a diagram illustrating an example of a processing configuration of the terminal according to a variation of the example embodiment of the present disclosure;

FIG. 17 is a diagram illustrating an example of a processing configuration of the server apparatus according to the variation of the example embodiment of the present disclosure;

FIG. 18 is a diagram illustrating an example of a processing configuration of the signage according to the variation of the example embodiment of the present disclosure;

FIG. 19 is a diagram illustrating an example of a schematic configuration of the information processing system according to a variation of the example embodiment of the present disclosure; and

FIG. 20 is a diagram illustrating an example of a hardware configuration of the server apparatus of the present disclosure.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

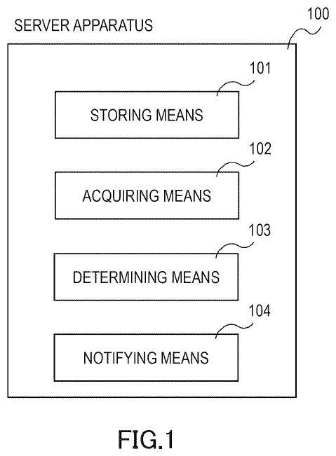

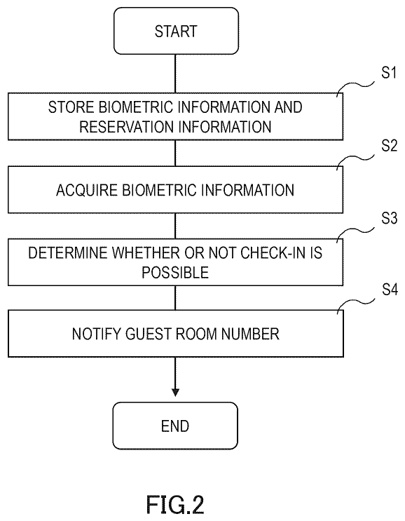

The server apparatus 100 according to an example embodiment includes a storing means 101, an acquiring means 102, a determining means 103, and a notifying means 104 (see FIG. 1). The storing means 101 stores biometric information and reservation information for each of a plurality of reservation holders of hotel stay (step S1 in FIG. 2). The acquiring means 102 acquires biometric information of a visitor who has visited a hotel (step S2). The determining means 103 identifies the visitor from among the plurality of reservation holders of hotel stay by performing a matching processing using the acquired biometric information and the stored biometric information, and determines whether or not the identified visitor is allowed to check in based on the reservation information of the identified visitor (step S3). When it is determined that the identified visitor is allowed to check in, the notifying means 104 sets the identified visitor as a hotel guest and notifies a terminal possessed by the hotel guest of a guest room number assigned to the hotel guest (step S4).

The server apparatus 100 acquires biometric information of the visitor to the hotel and performs biometric authentication using the acquired biometric information. The server apparatus 100 identifies the visitor who has visited the hotel from among the reservation holders of the hotel stay by biometric authentication. When a check-in procedure of the identified visitor is successfully completed, the server apparatus 100 notifies the guest room number to the visitor. As a result, a hotel user can enter the guest room assigned by the server apparatus 100 without stopping by a front desk of the hotel. In other words, convenience for the hotel user is improved.

Hereinafter, specific example embodiments will be described in more detail with reference to drawings.

### First Example Embodiment

A first example embodiment will be described in more detail with reference to drawings.

### System Configuration

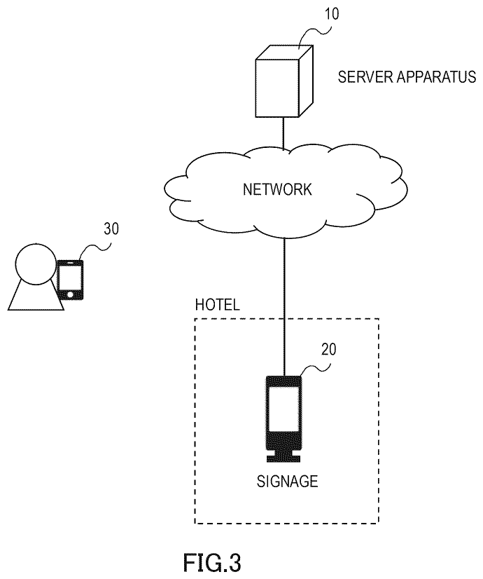

FIG. 3 is a diagram illustrating an example of a schematic configuration of an information processing system according to an example embodiment of the present application. As shown in FIG. 3, the information processing system includes a server apparatus 10 and a signage 20.

The server apparatus 10 realizes a main operation of a hotel. Specifically, the server apparatus 10 performs control and management, and so on related to hotel guests. For example, the server apparatus 10 stores information on the hotel guests (for example, name, gender, address, date of birth, biometric information) and reservation information (for example, length of stay, room type, and so on). The server apparatus 10 uses the reservation information to realize a check-in procedure, check-out procedure, and so on for the hotel guest.

The server apparatus 10 may be installed in the hotel or on a network (on a cloud).

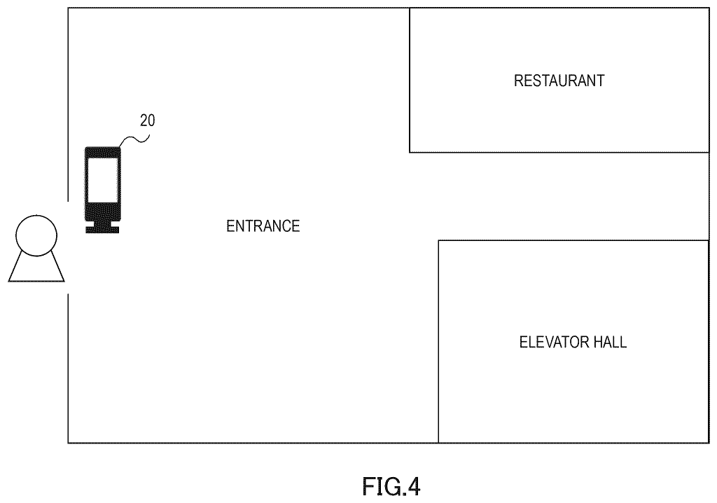

The signage 20 is a device that provides guidance related to a restaurant or the like operating in the hotel. The signage 20 is a device installed in the hotel and equipped with a camera. The signage 20 is installed at an entrance, or the like, as shown in FIG. 4. The signage 20 includes a camera and is installed so that the signage 20 can capture an image of a hotel user who enters or exits the hotel (in particular, a user who enters the hotel).

As shown in FIG. 3, the user (hotel guest) possesses a terminal 30. The user uses the terminal 30 to make a reservation for a hotel, and so on. For example, a mobile terminal such as a smartphone, tablet, or the like is shown as an example, for the terminal 30.

Here, each guest room in the hotel can be unlocked with a digital key. More specifically, a reading device for reading the digital key is attached to the door of each guest room.

For example, the reading device acquires the digital key by a short-range wireless communication means such as a Bluetooth (registered trademark) or NFC (Near Field Communication). For example, when the NFC is used, the user touches the terminal 30, in which the digital key is stored, to the reading device. The reading device acquires the digital key by communicating with the terminal 30 and unlocks an electronic lock when the digital key corresponding to his or her room is provided.

Alternatively, the terminal 30 may display the digital key in a form of a two-dimensional barcode in response to an operation by the user. The reading device may acquire the digital key by reading the two-dimensional barcode.

Note that a more detailed description will be omitted since unlocking the door with the digital key is obvious to those skilled in the art and is different from the purpose of the present application.

The apparatuses illustrated in FIG. 3 are connected to each other. Specifically, the server apparatus 10 and the signage 20 are connected by wired or wireless communication means and are configured to be able to communicate with each other.

The configuration of the information processing system shown in FIG. 3 is an example and is not intended to limit the configuration of the authentication system. For example, the system may include a plurality of the server apparatuses 10. Alternatively, the hotel may include a plurality of the signage 20 installed in the hotel.

### Outline of Operation

Next, a schematic operation of the information processing system according to the first example embodiment will be described.

### Installation of Application

A user installs a “hotel application” on the terminal 30. The user acquires the hotel application by any means and installs the application on the terminal 30. For example, the user operates the terminal 30 to access a web page provided by the server apparatus 10 and acquire the hotel application from the web page.

### Initial Registration

At first, the user starts the hotel application and registers his or her name, date of birth, gender, address, biometric information, e-mail address, and so on in the hotel application.

Note that examples of the biometric information include data (feature values) calculated from physical features unique to an individual, such as a face, a fingerprint, a voiceprint, a vein, a retina, or an iris pattern of an eye. Alternatively, the biometric information may be image data such as a face image, a fingerprint image, and so on. The biometric information may be anything that includes physical characteristics of a user as information. In the present application, a case in which biometric information about a “face” of a person (a face image or a feature value generated from the face image) is used will be described.

In the following description, information related to a user, such as the name, date of birth, gender, address, and biometric information of the user, will be collectively referred to as “user information”. Note that in addition to the name, gender, and so on, the user information includes contact information (e-mail address that can be received by the terminal 30), credit card information, and so on.

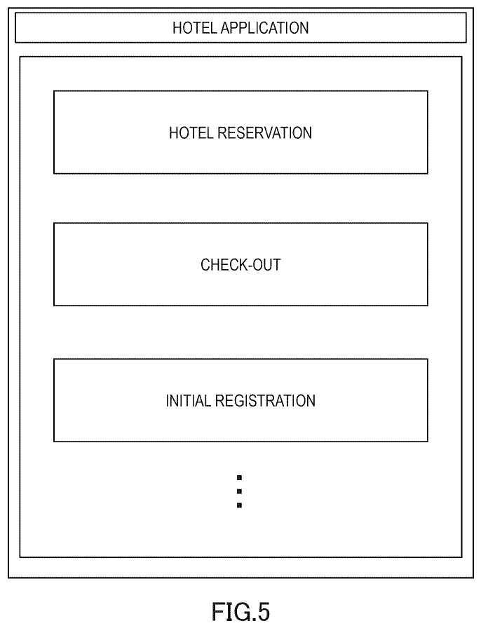

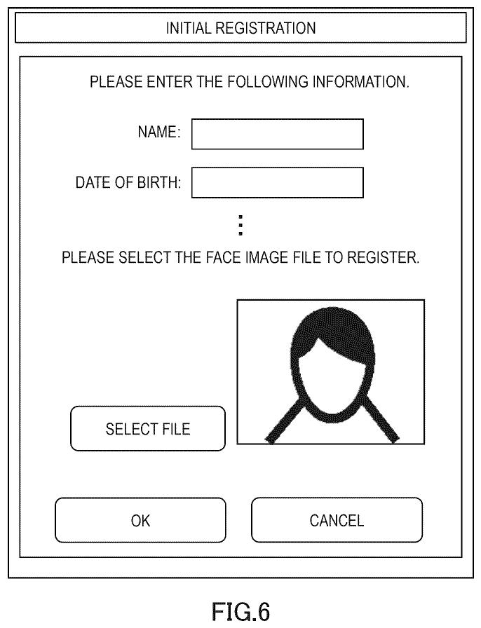

When the hotel application is launched, a menu screen as shown in FIG. 5 is displayed on terminal 30. When the user uses the hotel application for the first time, the user presses an “initial registration” button. In response to pressing the button, the terminal 30 displays a GUI (Graphical User Interface) as shown in FIG. 6 and acquires the user information.

The hotel application (the terminal 30) stores the acquired user information.

### Reservation for Hotel

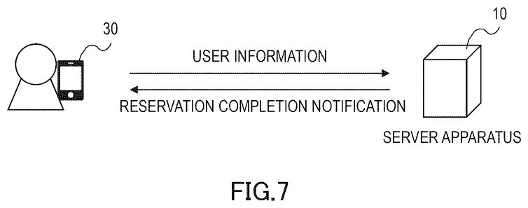

Once the user has completed the initial registration, the user can make a reservation for a hotel (a guest room). In this case, the user operates the terminal 30 and presses a “hotel reservation” button on a menu screen shown in FIG. 5. In response to the pressing of the button, the terminal 30 accesses a reservation site provided by the server apparatus 10. At that time, terminal 30 transmits the user information stored internally to the server apparatus 10 (see FIG. 7).

The user makes a reservation for a guest room on the reservation site. Note that a detailed description of making a reservation for the guest room will be omitted. The server apparatus 10 provides the user with information such as room availability, price, and the like. The user determines which guest room to reserve, taking into consideration the purpose of the stay, the type of room, and so on.

When the server apparatus 10 completes the reservation for the guest room of the user, the server apparatus 10 stores the user information of a reservation holder of hotel stay and reservation information in association with each other in a reservation holder management database. The reservation information includes a reservation number that identifies the reservation, the length of stay (check-in date, check-out date), the type of guest room, or the like. Details of the reservation holder management database will be described below.

When the reservation of the guest room is completed, the server apparatus 10 transmits a “reservation completion notification” to the terminal 30 that includes the reservation information. The hotel application (the terminal 30) stores the reservation information that is included in the received reservation completion notification.

### Check-In

On the day of check-in, the user visits the hotel where the user has made a reservation. The signage 20 captures an image of a visitor who enters an entrance. For example, the signage 20 detects the visitor who passes in front of the signage 20 or stops in front of the signage 20 by using a sensor or the like. The signage 20 acquires biometric information (face image) of the visitor by capturing an image of the detected visitor.

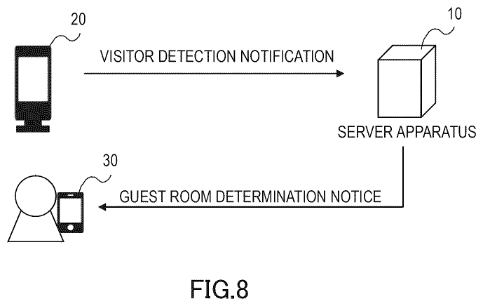

The signage 20 transmits a “visitor detection notification” that includes the acquired biometric information to the server apparatus 10 (see FIG. 8). The server apparatus 10 performs biometric authentication using the biometric information included in the visitor detection notification and the biometric information stored in the reservation holder management database.

When the reservation of the visitor identified by the biometric authentication (a person to be detected by the signage 20) is valid, the server apparatus 10 sets the visitor who has visited the hotel as a hotel guest. The server apparatus 10 performs a check-in procedure for the hotel guest. Specifically, the server apparatus 10 determines the guest room in which the hotel guest will stay. The server apparatus 10 notifies the hotel guest (visitor to the hotel, person to be detected by the signage 20) of a room number of a determined guest room and a digital key for the determined guest room.

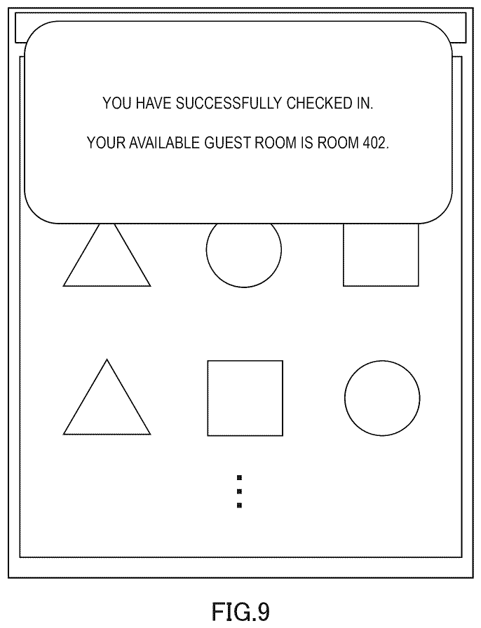

Specifically, the server apparatus 10 transmits a “guest room determination notice” that includes the room number of the guest room and the corresponding digital key to the terminal 30 of the hotel guest. In response to receipt of the notification, the hotel application of the terminal 30 notifies the user (hotel guest) of the fact that the check-in has been successful and the room number included in the guest room determination notification. For example, the hotel application of the terminal 30 displays information as shown in FIG. 9.

The hotel application also stores the received digital key.

The hotel guest passes through an elevator hall at the entrance, gets into an elevator, and goes to the notified guest room. The hotel guest unlocks the door using the digital key notified by the server apparatus 10 and enters the room.

In this way, the hotel user (hotel guest) can enter his or her assigned guest room without stopping by the front desk of the hotel. Furthermore, the hotel user does not need to have direct interaction with a hotel employee.

Next, details of the individual apparatuses included in the information processing system according to the first example embodiment will be described.

### Terminal

Examples of the terminal 30 include a mobile terminal device such as a smartphone, a mobile phone, a game console, a tablet, and so on. The terminal 30 can be any equipment or device as long as the terminal 30 can accept an operation by a user and can communicate with the server apparatus 10, and so on.

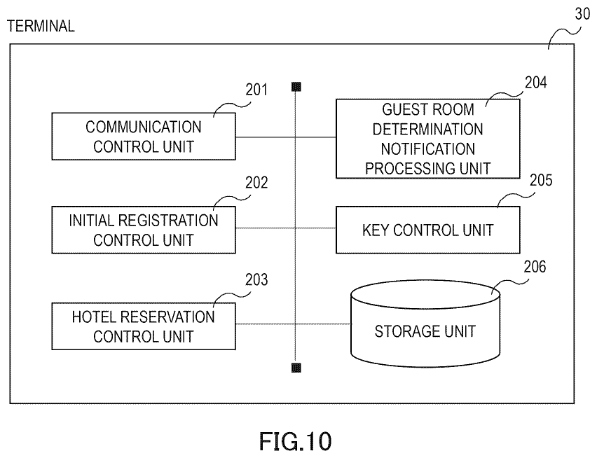

FIG. 10 is a diagram illustrating an example of a processing configuration (processing modules) of the terminal 30 according to the example embodiment of the present application. Referring to FIG. 10, the terminal 30 includes a communication control unit 201, an initial registration control unit 202, a hotel reservation control unit 203, a guest room determination notification processing unit 204, a key control unit 205, and a storage unit 206.

The communication control unit 201 is means for controlling communication with other apparatuses. For example, the communication control unit 201 receives data (packets) from the server apparatus 10. In addition, the communication control unit 201 transmits data to the server apparatus 10. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The initial registration control unit 202, the hotel reservation control unit 203, the guest room determination notification processing unit 204, and the key control unit 205 realize the hotel application installed on the terminal 30. A detailed description related to the installation of the hotel application will be omitted. This is because the installation of the application is obvious to those skilled in the art and is not the purpose of the present application.

The initial registration control unit 202 is means for controlling the initial registration when a user uses the hotel application. When the “initial registration” button is pressed on a menu screen of the hotel application, the initial registration control unit 202 displays a GUI as shown in FIG. 6 and acquires user information registration (for example, name, date of birth, biometric information, e-mail address, and so on).

The initial registration control unit 202 stores the acquired user information registration unit in the storage unit 206.

The hotel reservation control unit 203 is means for performing a control related to a hotel reservation. When the “hotel reservation” button is pressed on the menu screen of the hotel application, the hotel reservation control unit 203 accesses a predetermined reservation site. Specifically, the hotel reservation control unit 203 accesses the reservation site provided by the server apparatus 10.

At that time, the hotel reservation control unit 203 transmits the user information (name, date of birth, biometric information, e-mail address, and so on) stored in the storage unit 206 to the server apparatus 10.

After that, the hotel reservation control unit 203 inputs information such as the length of stay, type of guest room, and so on into the server apparatus 10 in accordance with an operation by the user. When the reservation made by the user is accepted, the hotel reservation control unit 203 receives a reservation completion notification from the server apparatus 10.

The reservation completion notification includes the reservation information such as the reservation number, length of stay, room type. The hotel reservation control unit 203 stores the reservation information in the storage unit 206.

The guest room determination notification processing unit 204 is means for processing a guest room determination notification received from the server apparatus 10. When the guest room determination notification processing unit 204 receives the guest room determination notification, the guest room determination notification processing unit 204 performs a pop-up display, for example, as shown in FIG. 9. In response to receiving the guest room determination notification, the guest room determination notification processing unit 204 notifies the user of the fact that the user has successfully checked in and the room number of the guest room assigned to the user.

Moreover, the guest room determination notification processing unit 204 stores the digital key included in the guest room determination notification in the storage unit 206.

The key control unit 205 is means for performing a control related to the digital key for unlocking the door of the guest room.

With respect to an exchange of the digital key between the reading device installed in the guest room and the terminal 30, when an NFC is used, the key control unit 205 receives a request for providing the digital key from the reading device attached to the door of the guest room. In response to receiving the request, the key control unit 205 transmits a response that includes the digital key stored in the storage unit 206 to the reading device.

With respect to the exchange of the digital key between the reading device and the terminal 30, when a two-dimensional barcode is used, the key control unit 205 converts the digital key into the two-dimensional barcode in response to an operation by the user. The key control unit 205 displays the two-dimensional barcode generated from the digital key.

The storage unit 206 is means for storing information necessary for the operation of the terminal 30.

### Server Apparatus

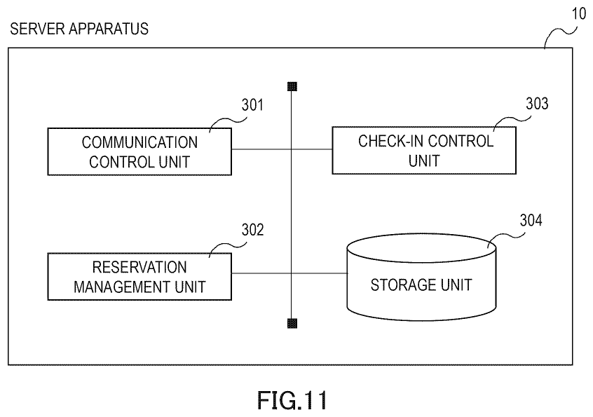

FIG. 11 is a diagram illustrating an example of a processing configuration (processing modules) of the server apparatus 10 according to the example embodiment of the present application. Referring to FIG. 11, the server apparatus 10 includes a communication control unit 301, a reservation management unit 302, a check-in control unit 303, and a storage unit 304.

The communication control unit 301 is means for controlling communication with other apparatuses. For example, the communication control unit 301 receives data (packets) from the terminal 30. In addition, the communication control unit 301 transmits data to the terminal 30. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The reservation management unit 302 is means for managing the reservation of the hotel (guest room) by the user. The reservation management unit 302 receives user information from the terminal 30 that has accessed the predetermined reservation site. In response to receiving the user information, the reservation management unit 302 displays a GUI on the terminal 30 for the user to select the length of stay, type of guest room, and so on.

When the user finishes making a selection, the reservation management unit 302 determines whether or not the reservation requested by the user can be accepted. The reservation management unit 302 determines whether the reservation can be accepted or not by referring to a database that manages room availability and so on.

When the reservation management unit 302 accepts the reservation requested by the user, the reservation management unit 302 transmits a reservation completion notification unit that includes the reservation information to the terminal 30. The reservation information includes the reservation number that identifies the reservation, the length of stay, and the type of guest room, and so on.

After the reservation management unit 302 transmits the reservation completion notification to the terminal 30, the reservation management unit 302 stores the user information and reservation information of a reservation holder of hotel stay in the reservation holder management database.

At that time, the reservation management unit 302 generates a feature value from the biometric information (face image).

Note that since an existing technology can be used to generate the feature values by the reservation management unit 302, a detailed description thereof will be omitted. For example, the reservation management unit 302 extracts eyes, nose, mouth, and so on as feature points from the face image. After that, the reservation management unit 302 calculates the location of individual feature point and the distance between individual feature points as a feature value (generate a feature vector consisting of a plurality of feature values).

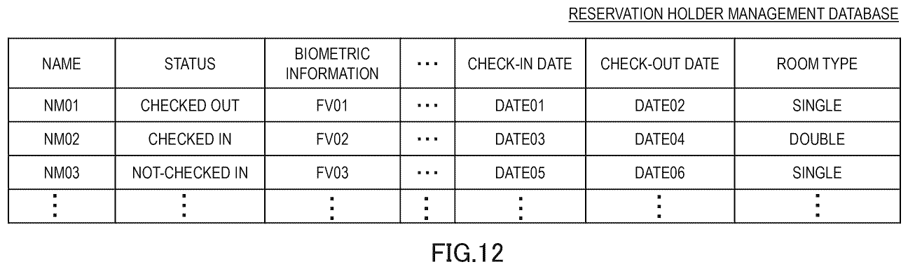

After the reservation management unit 302 generates the feature value, the reservation management unit 302 adds a new entry to the reservation holder management database, and stores the user information and reservation information in the entry. Specifically, the reservation management unit 302 stores the name, gender, date of birth, address, biometric information (feature value), e-mail address, state, reservation number, length of stay, and type of guest room (single, double, and so on) of the reservation holder of hotel stay in association with each other in the reservation holder management database (see FIG. 12).

Note that the reservation holder management database shown in FIG. 12 is an example, and is not meant to limit the items to be stored. For example, a “face image” may be registered in the reservation holder management database as the biometric information.

The check-in control unit 303 is means for performing a control related to the check-in of the reservation holder of hotel stay. The check-in control unit 303 processes the “visitor detection notification” received from the signage 20.

The check-in control unit 303 includes a function as an acquiring means, a function as a determining means, and a function as a notifying means. The acquiring means acquires biometric information of a visitor who has visited the hotel. The determining means identifies the visitor from among a plurality of reservation holders of hotel stay by performing a matching processing using the acquired biometric information and the stored biometric information. Further, the determining means determines whether or not the identified visitor is allowed to check in based on the reservation information of the identified visitor. When it is determined that the identified visitor can check in, the notifying means sets the identified visitor as a hotel guest and notifies the terminal 30 possessed by the hotel guest of a guest room number of a guest room assigned to the hotel guest.

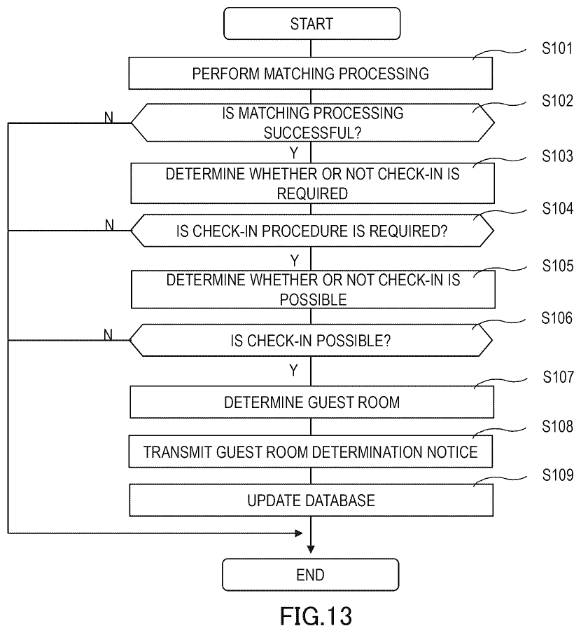

FIG. 13 is a flowchart illustrating an example of an operation of the check-in control unit 303 according to the example embodiment of the present application. Referring to FIG. 13, the operation of the check-in control unit 303 will be described.

When the check-in control unit 303 receives a visitor detection notification, the check-in control unit 303 performs a matching processing using the biometric information included in the notification and the biometric information stored in the reservation holder management database (step S101).

At first, the check-in control unit 303 calculates a feature value from a face image included in the visitor detection notification.

Next, the check-in control unit 303 sets the feature value calculated from the face image included in the visitor detection notification as a target of matching and performs a matching processing between the feature value and feature values, the feature values being calculated from face images, registered in the reservation holder management database. More specifically, the check-in control unit 303 sets the above calculated feature value (feature vector) as the target of matching and performs 1-to-N matching (Nis a positive integer, and the same applies to the following description) between the feature value and the plurality of feature values acquired from the reservation holder management database.

The check-in control unit 303 calculates similarities between the feature value to be matched and each of the plurality of feature values on the registration side. For the individual similarity, the chi-squared distance, the Euclidean distance, and so on may be used. A longer distance represents a lower similarity, and a shorter distance represents a higher similarity.

When there exists a feature value whose similarity between the feature to be matched is equal to or greater than a predetermined value among the plurality of feature values generated from the plurality of face images, the check-in control unit 303 determines that the matching processing has been successful. When the matching processing has been successful, the reservation holder of hotel stay with the entry with the highest similarity is identified as the visitor (person to be detected) detected by the signage 20.

The check-in control unit 303 determines that the matching processing has failed when there are no feature values as described above.

When the matching processing has failed (step S102, No branch), the check-in control unit 303 does not perform any special processing.

When the matching processing has been successful (step S102, Yes branch), the check-in control unit 303 determines whether or not the check-in procedure for the reservation holder identified by the matching processing is required (determining whether or not check-in is required; step S103)

Specifically, when the status of the reservation holder of hotel stay identified by the matching processing is “checked in” or “checked out”, the check-in control unit 303 determines that the check-in procedure for the visitor detected at the signage 20 is not required.

When the status of the reservation holder of hotel stay identified by the matching processing is “not checked-in”, the check-in control unit 303 determines that the check-in procedure for the visitor detected at the signage 20 is required.

When the check-in procedure is not required (step S104, No branch), the check-in control unit 303 does not perform any special processing.

When the check-in procedure is required (step S104, Yes branch), the check-in control unit 303 determines whether the visitor detected at the signage 20 is allowed to check in or not (step S105).

Specifically, when the date and time when the visitor visited the hotel is the scheduled check-in date of the hotel reservation holder of hotel stay identified by the matching process, and is included in the time period that is available for check-in as set by the hotel, the check-in control unit 303 determines that the visitor is allowed to check-in.

On the other hand, when the date and time when the visitor visited the hotel is not the scheduled check-in date of the reservation holder of hotel stay, the check-in control unit 303 determines that the visitor is not allowed to check in. Alternatively, when the date and time of when the visitor visited the hotel is not included in the time period that is available for check-in as set by the hotel (for example, from 15:00 to 22:00), the check-in control unit 303 determines that the visitor is not allowed to check in.

When the visitor is not allowed to check in (step S106, No branch), the check-in control unit 303 does not take any special action.

When the visitor is allowed to check in (step S106, Yes branch), the check-in control unit 303 sets the visitor as a hotel guest and determines the guest room in which the hotel guest will stay (step S107). Specifically, the check-in control unit 303 refers to a database or the like that manages the status of guest rooms and determines a guest room suitable for the type of guest room that the hotel guest has reserved.

Once the guest room is determined, the check-in control unit 303 transmits a “guest room determination notification” that includes the room number of the determined guest room and the digital key of the guest room to the terminal 30 of the hotel guest (step S108). Note that the check-in control unit 303 reads the e-mail address from the entry of the reservation holder of hotel stay identified by the matching processing and transmits the guest room determination notification to the e-mail address.

Note that the guest room determination notification is handed over to the hotel application via a mailer in the terminal 30. The hotel application displays a message as shown in FIG. 9 based on the acquired guest room determination notification. Alternatively, the check-in control unit 303 may transmit the guest room determination notification toward the hotel application currently running in the terminal 30, instead of or in addition to the e-mail address. In this case, the hotel application communicates with the server apparatus 10 to establish a session when the hotel application is launched. At that time, the terminal 30 and the server apparatus 10 transmit and receive an ID (for example, an email address) that identifies the user. The server apparatus 10 identifies the user using the ID and transmits the guest room determination notification to the hotel application with which the session has been established.

The check-in control unit 303 also updates the status of the hotel guest who has completed check-in (the reservation holder of hotel stay who has been assigned a guest room) to “checked in”. The check-in control unit 303 updates the status field in the reservation holder management database to “checked in” (update database; step S109).

In this way, the check-in control unit 303 identifies a visitor who has visited the hotel from among a plurality of reservation holders of hotel stay by performing biometric authentication. The check-in control unit 303 determines whether or not a check-in procedure is required for the identified visitor in accordance with the check-in status (checked in or not checked in) of the identified visitor. The check-in control unit 303 proceeds with the check-in procedure for the identified visitor when the check-in of the identified visitor is incomplete (when the check-in status is not yet completed). Specifically, the check-in control unit 303 determines whether or not the identified visitor is allowed to check in, and sets the visitor who has successfully checked in as a hotel guest. The check-in control unit 303 notifies the hotel guest of the digital key of the guest room together with the guest room number of the guest room assigned to the hotel guest. In other words, the check-in control unit 303 transmits the guest room number of the guest room assigned to the hotel guest and the digital key of the guest room assigned to the hotel guest to the terminal 30 possessed by the hotel guest.

The storage unit 304 is means for storing information necessary for an operation of the server apparatus 10. For example, the storage unit 304 stores biometric information and reservation information of each of a plurality of reservation holders of hotel stay in association with each other.

### Signage

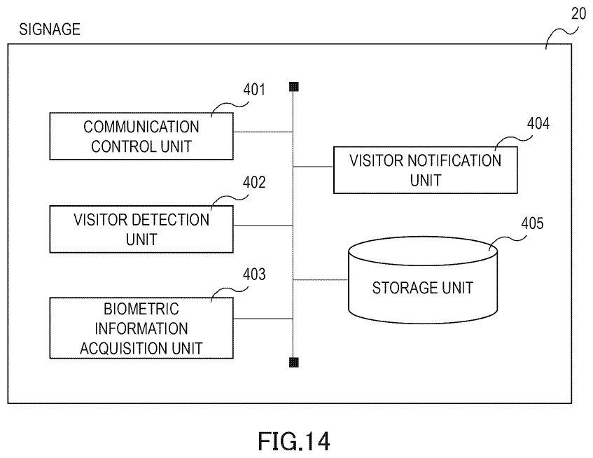

FIG. 14 is a diagram illustrating an example of a processing configuration (processing modules) of the signage 20 according to the example embodiment of the present application. Referring to FIG. 14, the signage 20 includes a communication control unit 401, a visitor detection unit 402, a biometric information acquisition unit 403, a visitor notification unit 404, and a storage unit 405.

The communication control unit 401 is means for controlling communication with other apparatuses. For example, the communication control unit 401 receives data (packets) from the server apparatus 10. In addition, the communication control unit 401 transmits data to the server apparatus 10. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit that receives data from other apparatuses and a function as a transmitting unit that transmits data to other apparatuses.

The visitor detection unit 402 is means for detecting a visitor (hotel user) to hotel.

For example, the visitor detection unit 402 detects a person who passes in front of the signage 20 or a person who stands in front of the signage 20 using a motion sensor or the like.

Alternatively, the visitor detection unit 402 may detect a visitor by analyzing an image data acquired from a camera.

For example, the visitor detection unit 402 periodically or at a predetermined timing captures an image of a predetermined area. The visitor detection unit 402 determines whether or not the acquired image includes an image of a person, and when an image of a person is included, the visitor detection unit 402 determines that the visitor is present.

When the visitor detection unit 402 detects the presence of the visitor, the visitor detection unit 402 notifies the biometric information acquisition unit 403 of the fact.

The biometric information acquisition unit 403 is means for acquiring biometric information of the visitor. When the presence of the visitor is notified, the biometric information acquisition unit 403 controls the camera and captures an image of the detected visitor (hotel user). The biometric information acquisition unit 403 extracts a face image from image data acquired by capturing.

Note that a detailed description will be omitted since existing technology can be used for the face image extraction processing by the biometric information acquisition unit 403. For example, the biometric information acquisition unit 403 may extract a face image (a face area) from the image data by using a learning model learned by a CNN (Convolutional Neural Network). Alternatively, the biometric information acquisition unit 403 may extract a face image by using a technique such as template matching.

The biometric information acquisition unit 403 hands over the extracted face image to the visitor notification unit 404.

The visitor notification unit 404 is means for notifying the server apparatus 10 of biometric information of the detected visitor.

The visitor notification unit 404 transmits a visitor detection notification that includes the biometric information (face image) acquired from the biometric information acquisition unit 403 to the server apparatus 10.

The storage unit 405 is means for storing information necessary for an operation of the signage 20.

### System Operation

Next, operations of the information processing system according to the first example embodiment will be described.

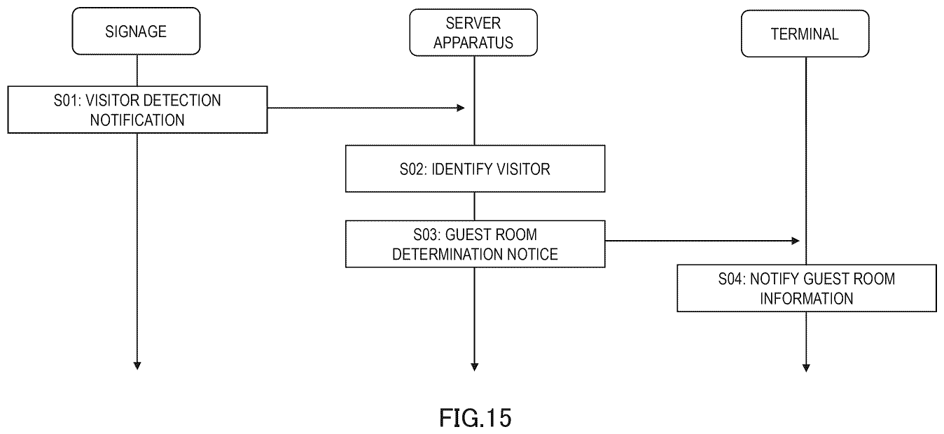

FIG. 15 is a diagram illustrating an example of an operation of the information processing system according to the example embodiment of the present application. Referring to FIG. 15, the operation of the information processing system according to the example embodiment of the present application at the time when a visitor to a hotel is detected will be described.

When the signage 20 detects a visitor to hotel (hotel user), the signage 20 transmits a visitor detection notification that includes biometric information of the user to the server apparatus 10 (step S01).

The server apparatus 10 performs a matching processing using biometric information included in the visitor detection notification and identifies the visitor (a reservation holder of hotel stay corresponding to the visitor) from among a plurality of reservation holders of hotel stay (step S02).

When the identified reservation holder of hotel stay is allowed to check in, the server apparatus 10 determines the guest room to be assigned to the reservation holder of hotel stay (the hotel guest) and transmits a guest room determination notification that includes the room number and digital key of the determined guest room to the terminal 30 (step S03).

The terminal 30 notifies information related to the assigned guest room to the user (notifying the guest room information; step S04). The user goes to the notified guest room and unlocks the door of the guest room using the digital key acquired from the server apparatus 10.

Note that a check-out procedure for the hotel guest is carried out together with a hotel staff member. The hotel staff member enters information identifying the hotel guest who has completed the check-out procedure (for example, name, guest room number, and reservation number) into the server apparatus 10. The reservation management unit 302 of the server apparatus 10 updates the status of the reservation holder who has completed the check-out procedure to “checked out”.

In addition, the reservation management unit 302 invalidates the digital key of the guest room assigned to the hotel guest who has completed the check-out procedure, and issues a new digital key for the guest room. Such operation of the reservation management unit 302 prevents the hotel guest who has completed the check-out procedure from entering the guest room again. In other words, the reservation management unit 302 includes a function as an invalidating means that, when a hotel guest checks out, the reservation management unit 302 performs a control related to invalidating the digital key notified to the hotel guest who has checked out.

Note that the reservation management unit 302 may delete an entry (an entry in the reservation holder management database) when a predetermined period of time has elapsed since the entry has been set as checked out.

Next, variations according to the first example embodiment will be described.

### Variation 1

A user may perform a check-out procedure using the hotel application. For example, the user launches the hotel application and presses the check-out button shown in FIG. 5.

In response to the pressing of the button, the terminal 30 transmits all or part of reservation information stored internally to the server apparatus 10. For example, the terminal 30 transmits a reservation number that identifies a reservation (stay) to the server apparatus 10.

The server apparatus 10 searches a reservation holder management database using the notified reservation number as a key, and identifies the corresponding entry. The server apparatus 10 calculates accommodation fee and the like based on information acquired from the identified entry, and so on, and performs a payment processing.

When the payment processing is completed, the server apparatus 10 notifies the terminal 30 of the fact and instructs the terminal 30 to delete the digital key. When the terminal 30 receives the instruction, the terminal 30 deletes the digital key stored internally.

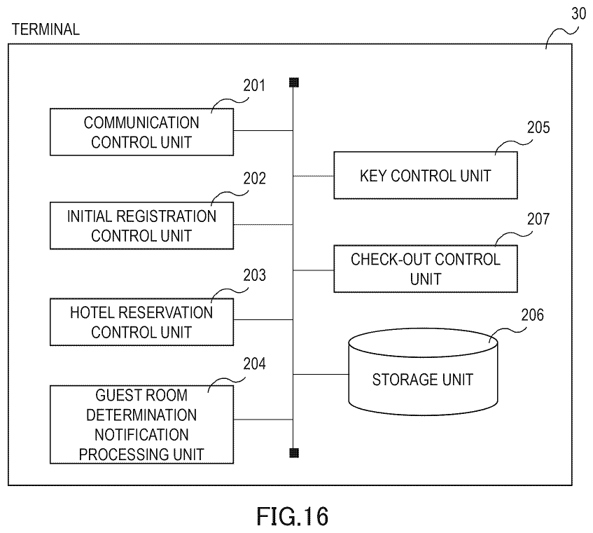

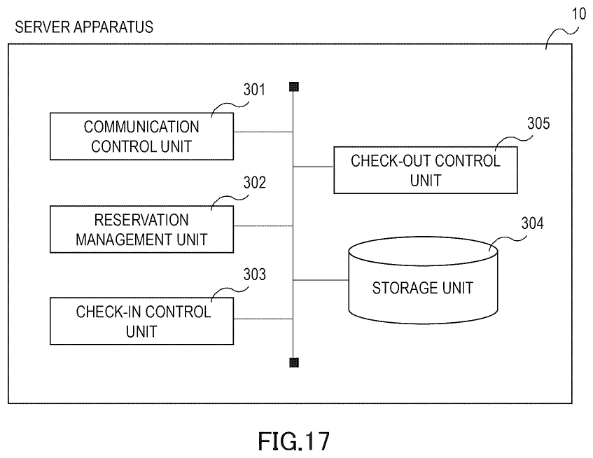

Note that when the check-out procedure is performed using the hotel application, the terminal 30 includes a check-out control unit 207 as shown in FIG. 16, and the server apparatus 10 includes a check-out control unit 305 as shown in FIG. 17. The check-out control unit 207 performs a control related to check-out of the terminal 30, and the check-out control unit 305 performs a control related to check-out of the server apparatus 10.

In this case, the check-out control unit 305 of the server apparatus 10 includes a function as an invalidating means that performs a control related to invalidating the digital key notified to the hotel guest who has checked out.

### Variation 2

The server apparatus 10 may process a visitor detection notification received from the signage 20 and transmit a predetermined message or the like to the signage 20 when a matching processing has failed or when it is determined that a visitor is not allowed to check in.

For example, when it is determined that a visitor (a person to be detected by the signage 20) is not allowed to check in, the check-in control unit 303 may transmit a message or the like to the signage 20 related to the time when the visitor is allowed to check in. Alternatively, when it is determined that the visitor is not allowed to check in, the check-in control unit 303 may transmit a message or the like related to a front desk where a hotel staff member is waiting to the signage 20. Alternatively, the check-in control unit 303 may transmit a message or the like that includes a telephone number where the visitor can speak with the hotel staff member to the signage 20.

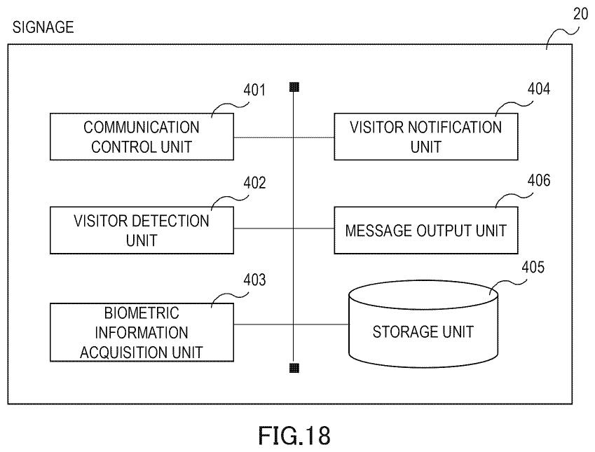

In this case, the signage 20 includes a message output unit 406, as shown in FIG. 18. The message output unit 406 displays a message received from the server apparatus 10 on a display or the like, or outputs the message as audio from a speaker.

### Variation 3

The above example embodiment describes a case in which the signage 20 detects a visitor to a hotel. However, the detection of the visitor to the hotel may be performed by other devices or the like instead of or in addition to the signage 20.

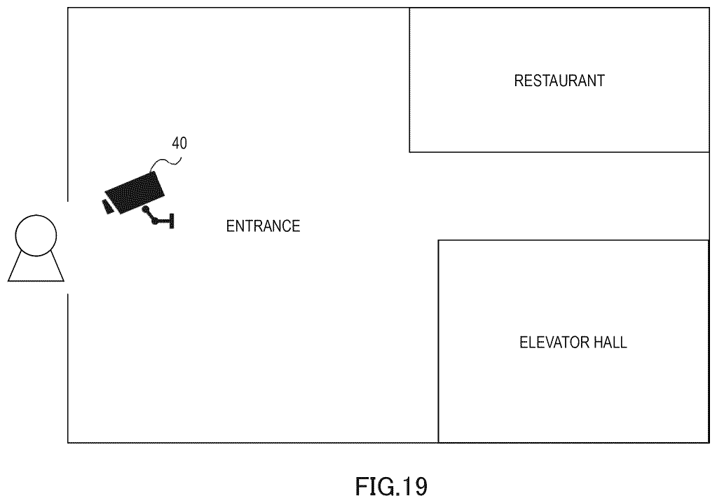

For example, as shown in FIG. 19, a surveillance camera 40 is installed at an entrance of a hotel. The surveillance camera 40 may include all or part of the functions of the signage 20 described above. In this case, when the surveillance camera 40 detects a visitor, the surveillance camera 40 may transmit a visitor detection notification that includes biometric information (face image) of the visitor to the server apparatus 10.

### Variation 4

The above example embodiment describes that a digital key distributed to a hotel guest may be used to unlock a guest room. The digital key distributed to the hotel guest may be used to board an elevator. More specifically, the digital key may be used to determine whether or not the elevator can be used.

For example, an NFC reader is installed on an operation panel of the elevator. When a user brings the terminal 30 close to the NFC reader, the terminal 30 transmits a digital key to the NFC reader. When the digital key acquired from the NFC reader is valid (when the digital key is a digital key distributed by the hotel), the operation panel of the elevator may enable the user to call the elevator, or open and close the door, and so on.

Utilization of such a digital key can prevent a person other than a hotel guest (a person who has not entered the hotel through a legitimate procedure) from using the elevator. In other words, security within the hotel is improved.

As described above, the server apparatus 10 according to the first example embodiment identifies a reservation holder of hotel stay who has visited the hotel from among the reservation holders who have made a reservation in advance by biometric authentication. The server apparatus 10 determines whether or not a check-in procedure is required for the visitor detected by the signage 20 based on the status (checked-in, not checked-in, or checked-out) of the identified reservation holder of hotel stay. The determination excludes performing the check-in procedure for a hotel guest who has already checked out or already checked in. In addition, the server apparatus 10 determines whether or not a hotel guest (visitor) who is determined to require the check-in procedure is allowed to check in, based on reservation information of the identified hotel guest by biometric authentication. The determination refuses to accept the reservation holder of hotel stay who has visited the hotel on a day different from the scheduled date and the reservation holder of hotel stay who has visited the hotel outside of the check-in hours. The server apparatus 10 sets the visitor determined to be allowed to check in as a hotel guest and assigns a guest room to the hotel guest. The server apparatus 10 notifies the hotel guest of the guest room number and digital key of the assigned guest room. By such operation of the server apparatus 10, the hotel user can enter the assigned guest room without stopping by a front desk of the hotel (unmanned check-in procedure is realized). The server apparatus 10 allows the user with legitimate authority to use the hotel without using a physical gate or the like, by transmitting the guest room number and digital key only to the user who has been allowed to check in. Since information necessary for using the hotel is notified to the terminal 30 of the user, the user does not need to stop in front of a terminal such as a check-in terminal (kiosk terminal) to perform a predetermined procedure, or the like. Moreover, the time spent by the hotel guest for check-in is saved, and convenience of the hotel guest is improved. In addition, congestion at the front desk of the hotel is avoided and burden on the hotel staff member is reduced. Furthermore, the guest room of the hotel of the present application can be unlocked using a digital key, and the unmanned check-in procedure can be realized at a low cost. That is, in order to unlock guest rooms using biometric authentication, it is necessary to install a camera in each guest room. However, in the information processing system of the present application, the unmanned check-in procedure can be realized by installing a single camera (the signage 20) at the entrance, and so on, of the hotel.

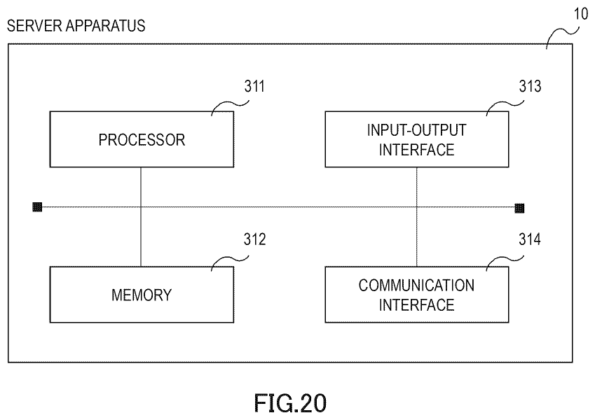

Next, a hardware configuration of an individual apparatus that constitutes the information processing system will be described. FIG. 20 is a diagram illustrating an example of a hardware configuration of the server apparatus 10.

The server apparatus 10 can be configured by an information processing apparatus (a so-called computer) and has a configuration illustrated as an example in FIG. 20. For example, the server apparatus 10 includes a processor 311, a memory 312, an input-output interface 313, a communication interface 314, and so on. The components such as the processor 311 are connected to an internal bus, and so on so that these components can communicate with each other.

The hardware configuration of the server apparatus 10 is not limited to the configuration illustrated in FIG. 20. The server apparatus 10 may include hardware not illustrated or may be configured without the input-output interface 313 if desired. In addition, the number of components, such as the number of processors 311, included in the server apparatus 10 is not limited to the example illustrated in FIG. 20. For example, a plurality of processors 311 may be included in the server apparatus 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. For example, the display apparatus is a liquid crystal display and so on. For example, the input device is a device, such as a keyboard, a mouse or a touch panel which receives user operations.

The communication interface 314 is a circuit, a module, and so on for performing communication with other apparatuses. For example, the communication interface 314 includes a NIC (Network Interface Card) and so on.

The functions of the server apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the terminal 30 and the signage 20, and so on, can each be configured by an information processing apparatus, and the basic hardware configuration of the terminal 30 and the signage 20 are the same as that of the server apparatus 10. Thus, description of the basic hardware configuration of the terminal 30 and the signage 20 will be omitted.

The server apparatus 10 includes a computer and can realize its functions by causing the computer to execute a program. In addition, the server apparatus 10 executes a control method of the server apparatus 10 by using this program.

### Variations

The configurations, operations, and so on of the information processing system according to the above example embodiment are examples and do not limit the present system configuration, and so on.

The above example embodiment describes a case in which the signage 20 and the surveillance camera 40 detect a visitor to hotel. The detection of the visitor to the hotel may be performed by the server apparatus 10. Specifically, the signage 20, and so on, periodically transmits image data to the server apparatus 10. The server apparatus 10 attempts to extract a face image from the received image data. When the face image is extracted, the server apparatus 10 determines that the visitor has been detected.

The above example embodiment describes a case in which the door of each guest room is unlocked by a digital key. The door may be unlocked by other means. For example, a password may be provided along with the guest room number, and the hotel guest may enter the password into a device installed on the door of the guest room. Alternatively, a camera may be installed in each guest room and biometric information of the hotel guest may be transmitted from the guest room to the server apparatus 10. The server apparatus 10 may instruct the guest room to unlock the door when the biometric authentication has been successful.

The server apparatus 10 may transmit the guest room number of the guest room assigned to the hotel guest to the signage 20 instead of or in addition to the terminal 30 of the hotel guest. The signage 20 may notify the visitor of the received guest room number. In this case, the signage 20 may display a message requesting that the hotel guest stop once in front of its own apparatus (the signage 20) for the check-in procedure. The signage 20 may transmit biometric information of the visitor (hotel user) standing in front of the signage 20 to the server apparatus 10. Note that the digital key of the guest room is transmitted to the terminal 30. In addition, the signage 20 that has received the guest room number from the server apparatus 10 may display a message that the digital key has been notified to the terminal 30, such as a smartphone.

The terminal 30 may perform identity verification at the time of user registration (at the time of initial registration). For example, the terminal 30 performs identity verification using an identification card such as a driver's license or passport that describes biometric information of a holder. The terminal 30 acquires biometric information (face image) from the identification card of the user. In addition, the terminal 30 acquires biometric information (face image) by capturing an image of the user. The terminal 30 may register user information when an authentication using two biometric information (one-to-one authentication) has been successful.

The above example embodiments describe a case in which guest room information is notified from the server apparatus 10 to a reservation holder of hotel stay as a target. Here, the information processing system of the present application can also be applied to a hotel user other than a hotel guest. For example, when a reservation holder who has made a reservation for a meeting room or a restaurant visits the hotel, the reservation holder may be identified by biometric authentication. In this case, the server apparatus 10 may transmit information related to the meeting room or restaurant of the identified reservation holder (for example, the location of the meeting room, or the like) to the terminal 30 of the user. Alternatively, the server apparatus 10 may transmit a digital key to enter the conference room to the terminal 30 of the user.

The above example embodiment describes a case in which a reservation holder management database is configured inside the server apparatus 10, but the database may be established in an external database server or the like. That is, some of the functions of the server apparatus 10 may be implemented in another apparatus. More specifically, the “reservation management unit (reservation management means)”, “check-in control unit (check-in control means)”, and so on described above may be implemented in any device included in that includes the system.

The above example embodiment describes a case in which a face image is transmitted from the terminal 30 to the server apparatus 10 as biometric information. However, a feature value generated from the face image may be transmitted from the terminal 30 to the server apparatus 10 as biometric information. Alternatively, the reservation holder information management database of the server apparatus 10 may store the face image as biometric information of a reservation holder of hotel stay instead of the feature value.

While the data exchange between each apparatus (the server apparatus 10, the signage 20, and the terminal 30) is not limited to any particular mode, data exchanged between these apparatuses may be encrypted. It is desirable that the biometric information and so on are transmitted and received between these apparatuses and encrypted data is transmitted and received in order to properly protect this information.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to information processing systems related to reservations for hotels and check-in procedures.

A part or the entirety of the example embodiments described above may be described as in the following supplementary notes, but is not limited to the followings.

### Supplementary Note 1

A server apparatus, including:
a storing means that stores biometric information and reservation information for each of a plurality of reservation holders of hotel stay;
an acquiring means that acquires biometric information of a visitor who has visited a hotel;
a determining means that identifies the visitor from among the plurality of reservation holders of hotel stay by performing a matching processing using the acquired biometric information and the stored biometric information, and determines whether or not the identified visitor is allowed to check in based on the reservation information of the identified visitor; and
a notifying means that sets the identified visitor as a hotel guest when the identified visitor is allowed to check in and notifies a terminal possessed by the hotel guest of a guest room number assigned to the hotel guest.

### Supplementary Note 2

The server apparatus according to supplementary note 1, wherein the acquiring means acquire, from a device equipped with a camera and installed in the hotel, biometric information of the visitor detected by the device.

### Supplementary Note 3

The server apparatus according to supplementary note 2, wherein the notifying means notifies the terminal possessed by the hotel guest of a digital key of the guest room assigned to the hotel guest together with the guest room number.

### Supplementary Note 4

The server apparatus according to supplementary note 3, wherein the determining means determines whether or not the identified visitor is allowed to check in when a check-in of the identified visitor is incomplete.

### Supplementary Note 5

The server apparatus according to supplementary note 4, further comprising an invalidating means that performs a control related to invalidating the digital key notified to the hotel guest who has checked out when the hotel guest checks out.

### Supplementary Note 6

The server apparatus according to any one of supplementary notes 3 to 5, wherein the digital key is used to determine whether or not an elevator can be used.

### Supplementary Note 7

The server apparatus according to according to any one of supplementary notes 2 to 5, wherein the device is a signage installed in the hotel or a surveillance camera installed in the hotel.

### Supplementary Note 8

A control method of a server apparatus, the control method including:
a storing step that stores biometric information and reservation information for each of a plurality of reservation holders of hotel stay;
an acquiring step that acquires biometric information of a visitor who has visited a hotel;
a determining step that identifies the visitor from among the plurality of reservation holders of hotel stay by performing a matching processing using the acquired biometric information and the stored biometric information, and determines whether or not the identified visitor is allowed to check in based on the reservation information of the identified visitor; and
a notifying step that sets the identified visitor as a hotel guest when the identified visitor is allowed to check in and notifies a terminal possessed by the hotel guest of a guest room number assigned to the hotel guest.

### Supplementary Note 9

The control method of the server apparatus according to supplementary Note 8, wherein the acquiring step acquires, from a device equipped with a camera and installed in the hotel, biometric information of the visitor detected by the device.

### Supplementary Note 10

The control method of the server apparatus according to supplementary note 9, wherein the notifying step notifies the terminal possessed by the hotel guest of a digital key of the guest room assigned to the hotel guest together with the guest room number.

### Supplementary Note 11

The control method of the server apparatus according to supplementary note 10, wherein the determining means determines whether or not the identified visitor is allowed to check in when a check-in of the identified visitor is incomplete.

### Supplementary Note 12

The control method of the server apparatus according to supplementary Note 11, further comprising an invalidating step that performs a control related to invalidating the digital key notified to the hotel guest who has checked out when the hotel guest checks out.

### Supplementary Note 13

The control method of the server apparatus according to any one of supplementary notes 10 to 12, wherein the digital key is used to determine whether or not an elevator can be used.

### Supplementary Note 14

The control method of the server apparatus according to according to any one of supplementary notes 9 to 12, wherein the device is a signage installed in the hotel or a surveillance camera installed in the hotel.

### Supplementary Note 15

A program causing a computer mounted on a server apparatus to perform processing for:
a storing processing that stores biometric information and reservation information for each of a plurality of reservation holders of hotel stay;
an acquiring processing that acquires biometric information of a visitor who has visited a hotel;
a determining processing that identifies the visitor from among the plurality of reservation holders of hotel stay by performing a matching processing using the acquired biometric information and the stored biometric information, and determines whether or not the identified visitor is allowed to check in based on the reservation information of the identified visitor; and
a notifying processing that sets the identified visitor as a hotel guest when the identified visitor is allowed to check in and notifies a terminal possessed by the hotel guest of a guest room number assigned to the hotel guest.

### Supplementary Note 16

The program according to supplementary note 14, wherein the acquiring processing acquires, from a device equipped with a camera and installed in the hotel, biometric information of the visitor detected by the device.

### Supplementary Note 17

The program according to supplementary note 16, wherein the notifying processing notifies the terminal possessed by the hotel guest of a digital key of the guest room assigned to the hotel guest together with the guest room number.

### Supplementary Note 18

The program according to supplementary note 17, wherein the determining processing determines whether or not the identified visitor is allowed to check in when a check-in of the identified visitor is incomplete.

### Supplementary Note 19

The program according to supplementary note 18, further performing an invalidating processing that performs a control related to invalidating the digital key notified to the hotel guest who has checked out when the hotel guest checks out.

### Supplementary Note 20

The program according to any one of supplementary notes 17 to 19, wherein the digital key is used to determine whether or not an elevator can be used.

### Supplementary Note 21

The program according to according to any one of supplementary notes 16 to 19, wherein the device is a signage installed in the hotel or a surveillance camera installed in the hotel.

Furthermore, all or part of the configurations described in supplementary note 2 to supplementary note 7, which depend on supplementary note 1, may also depend on supplementary note 8 and supplementary note 15 in the same manner as supplementary note 2 to supplementary note 7. Furthermore, not limited to supplementary note 1, supplementary note 8, and supplementary note 15, within the scope that does not deviate from the embodiments described above, all or part of the configurations described as supplementary notes may similarly depend on various hardware, software, various recording means for recording software, or systems.

The entire disclosure of the above patent literature is incorporated herein by reference thereto While the example embodiments of the present invention have thus been described, the present invention is not limited to these example embodiments. It is to be understood to those skilled in the art that these example embodiments are only examples and that various variations are possible without departing from the scope and sprit of the present invention. That is, the present invention of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. A server apparatus, comprising:
at least one memory storing a set of instructions; and
at least one processor configured to execute the set of instructions to:
store biometric information and reservation information for each of a plurality of reservation holders of hotel stay;
acquire biometric information of a visitor who has visited a hotel;
identify the visitor from among the plurality of reservation holders of hotel stay by performing a matching processing using the acquired biometric information and the stored biometric information, and determines whether or not the identified visitor is allowed to check in based on the reservation information of the identified visitor;
set the identified visitor as a hotel guest when the identified visitor is allowed to check in; and
notify a terminal possessed by the hotel guest of a guest room number assigned to the hotel guest.

2. The server apparatus according to claim 1, wherein
the at least one processor is further configured to execute the set of instructions to acquire, from a device equipped with a camera and installed in the hotel, biometric information of the visitor detected by the device.

3. The server apparatus according to claim 2, wherein
the at least one processor is further configured to execute the set of instructions to notify the terminal possessed by the hotel guest of a digital key of the guest room assigned to the hotel guest together with the guest room number.

4. The server apparatus according to claim 3, wherein
the at least one processor is further configured to execute the set of instructions to determine whether or not the identified visitor is allowed to check in when a check-in of the identified visitor is incomplete.

5. The server apparatus according to claim 4, wherein
the at least one processor is further configured to execute the set of instructions to perform a control related to invalidating the digital key notified to the hotel guest who has checked out when the hotel guest checks out.

6. The server apparatus according to claim 3, wherein the digital key is used to determine whether or not an elevator can be used.

7. The server apparatus according to according to claim 2, wherein the device is a signage installed in the hotel or a surveillance camera installed in the hotel.

8. A control method of a server apparatus, the control method comprising:
storing biometric information and reservation information for each of a plurality of reservation holders of hotel stay;
acquiring biometric information of a visitor who has visited a hotel;
identifying the visitor from among the plurality of reservation holders of hotel stay by performing a matching processing using the acquired biometric information and the stored biometric information, and determines whether or not the identified visitor is allowed to check in based on the reservation information of the identified visitor; and
setting the identified visitor as a hotel guest when the identified visitor is allowed to check in and
notifying a terminal possessed by the hotel guest of a guest room number assigned to the hotel guest.

9. The control method according to claim 8, comprising acquiring, from a device equipped with a camera and installed in the hotel, biometric information of the visitor detected by the device.

10. The control method according to claim 9, comprising notifying the terminal possessed by the hotel guest of a digital key of the guest room assigned to the hotel guest together with the guest room number.

11. The control method according to claim 10, comprising determining whether or not the identified visitor is allowed to check in when a check-in of the identified visitor is incomplete.

12. The control method according to claim 11, comprising performing a control related to invalidating the digital key notified to the hotel guest who has checked out when the hotel guest checks out.

13. A non-transitory computer-readable storage medium storing a program causing a computer mounted on a server apparatus to perform processing for:
storing biometric information and reservation information for each of a plurality of reservation holders of hotel stay;
acquiring biometric information of a visitor who has visited a hotel;
identifying the visitor from among the plurality of reservation holders of hotel stay by performing a matching processing using the acquired biometric information and the stored biometric information, and determines whether or not the identified visitor is allowed to check in based on the reservation information of the identified visitor; and
setting the identified visitor as a hotel guest when the identified visitor is allowed to check in;
notifying a terminal possessed by the hotel guest of a guest room number assigned to the hotel guest.
